(19) United States
(12) Patent Application Publication
(10) Pub. No.: US 2025/0371448 A1
(43) Pub. Date: Dec. 4, 2025

(54) WORK ITEM SIZING PREDICTIONS

(71) Applicant: International Business Machines Corporation, Armonk, NY (US)

(72) Inventors: Stephanie Carys SHUM, Wappingers Falls, NY (US); Patrick John CLAS, Pine Plains, NY (US); Jason Matthew STAPELS, Poughkeepsie, NY (US)

(21) Appl. No.: 18/676,004

(22) Filed: May 28, 2024

(51) Int. Cl. G06Q 10/0631; G06F 40/279

(52) U.S. Cl. CPC G06Q 10/0631; G06F 40/279

(57) ABSTRACT

Method and apparatus for work item sizing prediction are provided. A feature request is received. A plurality of feature keywords are extracted by processing descriptions of the feature request. A plurality of team-specific keywords are identified for a work item associated with the feature request. A work time vector representing the work item is generated using the team-specific keywords. A plurality of prior work items that are related to the team-specific keywords are identified. A plurality of prior work item vectors are generated, where each respective prior work item vector corresponds to a respective prior work item, among the plurality of identified prior work items. A similarity score between the work item vector and each of the prior work item vectors is calculated. A time to complete the work item is estimated based on the similarity score.

### BACKGROUND

The present disclosure relates to work item sizing prediction and, more specifically, to estimating sizings for new feature requests by utilizing keyword correlation databases and vector-based similarity analyses.

Work item sizing is an important aspect of software development, which involves estimating the amount of time and effort required to complete a portion of the work. Typically, these sizings are performed by senior engineers who have a deep understanding of the project's technical and operational requirements. This knowledge allows them to accurately estimate the resources and timelines required. However, when senior engineers are unfamiliar with a specific subject, their estimation may become inaccurate, which may cause disruptions in project management, such as missing its deadline. This not only causes losses of revenue and business but also impairs client trust.

### SUMMARY

One embodiment presented in this disclosure provides a method, including receiving a feature request, extracting a plurality of feature keywords by processing descriptions of the feature request, identifying a plurality of team-specific keywords for a work item associated with the feature request, generating a work item vector using the team-specific keywords, identifying a plurality of prior work items that are related to the team-specific keywords, generating a plurality of prior work item vectors, where each respective prior work item vector corresponds to a respective prior work item, among the plurality of identified prior work items, calculating a similarity score between the work item vector and each of the prior work item vectors, and estimating a time to complete the work item based on the similarity score.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs that, when executed by the one or more computer processors, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example feature request and its related team-specific work items, according to some embodiments of the present disclosure.

FIG. 3 depicts an example of a workflow for creating keyword mappings for completed feature requests, according to some embodiments of the present disclosure.

FIG. 4 depicts an example of a workflow for predicting team-specific work item sizings for a new feature request, according to some embodiments of the present disclosure.

FIG. 5 depicts an example method for generating and storing keyword mappings in a correlation database, according to some embodiments of the present disclosure.

FIGS. 6A and 6B depict an example method for estimating sizings for team-specific work items in new feature development, according to some embodiments of the present disclosure.

FIG. 7 is a flow diagram depicting an example method for work item sizing predictions, according to some embodiments of the present disclosure.

### DETAILED DESCRIPTION

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In software development, a work item is a primary unit of work completion within a project. When receiving a request to add a new feature, for example, the first step typically involves breaking down the new feature into smaller, manageable work items. Each work item represents an individual task that can be assigned to different teams or engineers, and these work items collectively contribute to the completion of the requested feature. Work item sizing is a process of determining the amount of time and effort required to complete each work item. Various units may be used in sizing, such as hours, days, or person months (which represent the amount of work one person can complete in one month).

Accurate work item sizing is important for project management and coordination as it allows for more precise budget and deadline estimations and facilitates more efficient resource allocation and project progress tracking. Conventionally, work item sizing is performed manually by senior engineers or project managers who have a vast amount of knowledge about the project's specific technologies and processes. The accuracy of the assessment highly depends on the person's familiarity with the tasks of interest. When an engineer is unfamiliar with the project details, this may lead to inaccurate sizings, thus resulting in missed deadlines, potential revenue loss, business disruption, and an impairment of client trust. Additionally, in software development, various teams tend to use team-specific terminologies or descriptions to detail the work related to a feature request. The diversity in language and writing styles makes it difficult to search through existing databases to generate a related and accurate work item sizing. This can lead to inconsistencies in work item estimations across different teams, which further complicates the process of project management and coordination.

The present disclosure provides techniques, systems, and methods for correlating feature keywords with team-specific keywords for historical work items and, by checking these correlations, generating accurate work item sizing for new feature requests. More specifically, the system uses natural language processing (NLP) techniques to extract keywords from both completed feature requests and related prior work items performed by different teams. These keywords are then mapped and correlated with each other to create a keyword correlation database. Such correlation mappings resolve the problem of diverse language use and styles in the descriptions of feature requests and work items.

When a new feature request is received, the system uses NLP techniques to extract keywords from the description of the new feature request. Utilizing the extracted feature keywords, the system then checks the keyword correlation database to identify similar or equivalent keywords used in team-specific prior work items. Once identified, the team-specific keywords are then used to generate a vector using techniques like Bag of Words (BoW), Term Frequency-Inverse Document Frequency (TF-IDF), or contextual word embeddings. The vector represents a new team-specific work item that needs to be completed for the new feature. With the identified team-specific keywords, the system also identifies one or more historical work items (also referred to in some embodiments as prior work items) that are similar to or potentially related to the new team-specific work item. In some embodiments, the identified historical work items were completed by the same team that is assigned the new work item. This approach may improve estimation accuracy, as work items completed by the same team provide a more relevant historical baseline considering consistent coding practices, skills, and tools. Vectors are also generated for each of the identified team-specific historical work items, to ensure both the new and historical work items are represented in the same vector space. The system then compares these vectors to measure the similarity between the new work item and the identified historical work items. Based on the outcomes of these similarity measurements, in some embodiments, the system may further refine the selection of the historical work items to a smaller and more relevant range. The refinement may involve selecting a number of top-rated historical work items with the highest similarity scores to the new team-specific work item. With these top-rated similar items, the system may utilize a weighted average calculation for these selected work items to estimate the time and effort required for completing the new work item.

In embodiments where achieving the new feature requires the collaboration of more than one team, the estimation process may be repeated individually for each team involved. This may include extracting and analyzing team-specific keywords, generating vectors for new and prior work items, and calculating the similarity to determine the most relevant prior work items for each team. Once the individual estimations are completed, the total effort required to implement the new feature is determined by adding the estimated efforts of all teams.

In some embodiments, a work item may require certain pre-planning activities (or actions) to be performed beforehand. These pre-planning activities (or actions) may include preparation work to ensure that launching the work item would not disrupt the normal operations of an application or system. For example, the pre-planning activities may include system architecture evaluation, risk assessment, or preliminary resource allocation. To manage these pre-planning activities, a database may be created that includes dictionary mappings between historical work items and their corresponding pre-planning activities. In some embodiments, the database may assign different weights to various types of correlations, such as direct correlation (e.g., pre-planning activity pointing to work item, work item pointing to pre-planning activity, self-described correlation) and indirect reference. When top-rated similar historical work items are selected, the system may search the pre-planning database to identify the related or mapped pre-planning activities for each prior work item. The system may then estimate the sizings of these pre-planning activities for each prior work item utilizing a weighted average calculation based on the assigned weights. For example, direct correlation may be assigned a higher weight as it represents a stronger necessity for pre-planning efforts than indirect reference. By incorporating the pre-planning activities into the overall work item sizing, the overall estimation for the new feature becomes more accurate.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

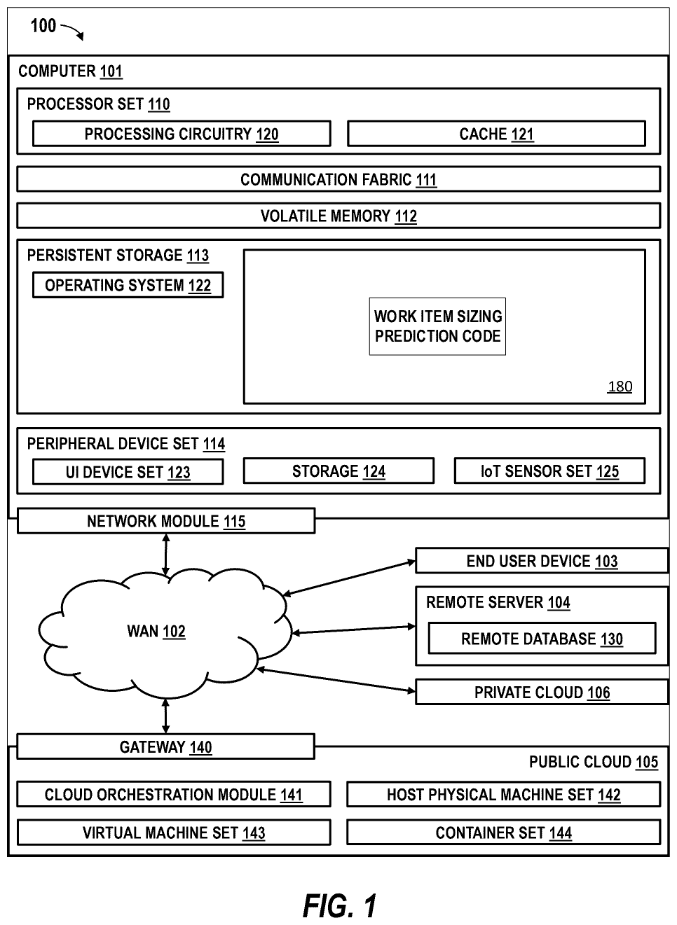

FIG. 1 depicts an example computing environment for the execution of at least some of the computer code involved in performing the inventive methods.

Computing environment 100 contains an example of an environment for the execution of at least some of the computer code involved in performing the inventive methods, such as Work Item Sizing Prediction Code 180. In addition to Work Item Sizing Prediction Code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Work Item Sizing Prediction Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Work Item Sizing Prediction Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Work Item Sizing Prediction Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

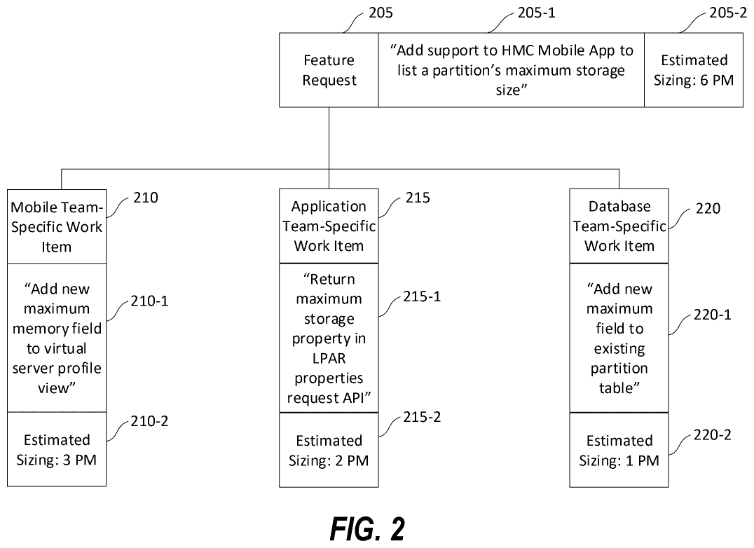

FIG. 2 depicts an example feature request 205 and its related team-specific work items 210, 215 and 220, according to some embodiments of the present disclosure. As used herein, a feature request 205 refers to a work request that is to be sized and implemented to enhance or modify a software application. The example depicted includes a feature request to add support to the HMC Mobile application (App) for listing a partition's maximum storage size. The feature request typically requires collaborative efforts across multiple teams to address various aspects of the application. As used herein, a work item refers to a granular unit of work that has been completed or will be completed by a single team. These work items collectively contribute to the completion of the feature. Each work item may include a specific task or set of tasks necessary to achieve a part of the overall feature implementation. As illustrated, the mobile team works on integrating a new maximum memory field into the virtual server profile view, the application team focuses on making the API to return maximum storage property information, and the database team is assigned the task of updating the database to include a new maximum field in the partition table.

As illustrated, the feature request 205 includes two main sections: the description section 205-1 and the estimated sizing section 205-2. The description section 205-1 provides the text description of the feature requested, such as “add support to HMC Mobile App to list a partition's maximum storage size.” The descriptions may then be processed to extract feature keywords. The estimated sizing section 205-2 details the time and/or effort estimated to complete the feature request. In the illustrated example, person month (PM) is used as the measurement metric to indicate the time and/or effort required. The estimated sizing section 205-2 provides a visual representation of the overall effort needed across different teams involved in the project.

In the illustrated example, there are three team-specific work items 210, 215, and 220 distributed among three different teams, each important to the feature's implementation. Each team-specific work item includes two sections: the description section (e.g., 210-1, 215-1, and 220-1) and the estimated sizing section (e.g., 210-2, 215-2, and 220-2). The description section provides a detailed text description of the specific tasks each team is assigned to perform. For example, in the mobile team-specific work item, the description section 210-1 includes a statement like “add new maximum memory field to virtual server profile view.” For the application team, the description section 215-1 reads “return maximum storage property in LPAR properties request API,” and for the database team, the description section 220-1 states “add new maximum field to existing partition table.” These descriptions may then be processed using NLP techniques to extract team-specific keywords. The estimated sizing sections 210-2, 215-2, and 220-2 provide the time and/or effort needed to complete each work item. As illustrated, PM is used as the measurement metric. For example, the mobile team's work item is estimated to take 3 PM, the application team's work item is estimated to take 2 PM, and the database team's work item is estimated to take 1 PM. The estimated sizing for the feature (e.g., 6 PM) is determined by summing up the estimated sizing for each team-specific work item (e.g., 3 PM, 2 PM, and 1 PM).

When the feature request has not yet been implemented, the estimated sizing section (e.g., 205-2, 210-2, 215-2, and 220-2) is included to provide estimations based on the available data and historical performance. When the feature request has been completed, the estimated sizing section may be replaced with an actual sizing section, which indicates the actual effort and/or time that was taken to achieve the feature.

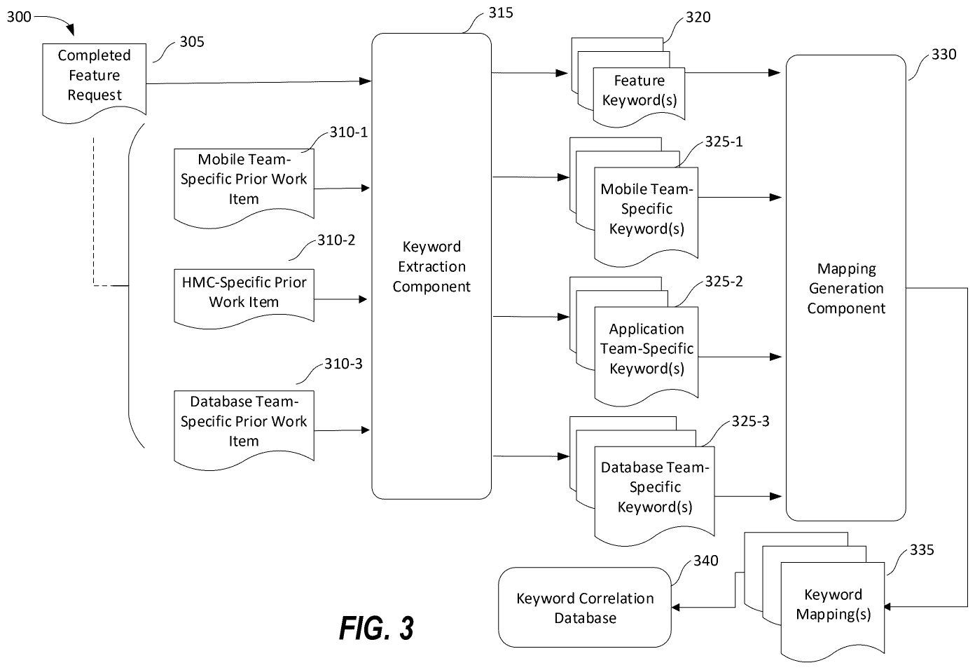

FIG. 3 depicts an example of a workflow 300 for creating keyword mappings for completed feature requests, according to some embodiments of the present disclosure.

In the example workflow 300, a completed feature request 305 is provided to the keyword extraction component 315. In some embodiments, the completed feature request 305 may correspond to the feature request 205 as depicted in FIG. 2, with a detailed description of “add support to HMC Mobile App to list a partition's maximum storage size” and an actual sizing of 6 PM. The keyword extraction component 315 processes the description of the completed feature request 305 to identify a set of relevant keywords 320. Using the feature request 205 as an example, the feature keywords 320 extracted may include terms such as “HMC Mobile APP,” “maximum,” “storage size,” and “partition.”

As illustrated, the completed feature request 305 is associated with three team-specific prior work items, including a mobile team-specific prior work item 310-1 (which may correspond to the mobile team-specific work item 210 as depicted in FIG. 2, with a description of “add new maximum memory field to virtual server profile view” and an actual sizing of 3 PM), an application team-specific prior work item 310-2 (which may correspond to the application-specific work item 215 as depicted in FIG. 2, with a description of “return maximum storage property in LPAR properties request API” and an actual sizing of 2 PM), and a database team-specific prior work item (which may correspond to the database team-specific work item 220 as depicted in FIG. 2, with a description of “add new maximum field to existing partition table” and an actual sizing of 1 PM). Each team-specific prior work item 310 is also provided to the keyword extraction component 315. The descriptions of these work items are then processed to extract keywords that are specifically related to each team's tasks. For example, the mobile team's keywords 325-1 may include “maximum,” “memory field,” “virtual server,” and “profile.” The application team's keywords 325-2 may include “maximum,” “storage property,” “API,” and “LPAR.” The database team's keywords 325-3 may include “maximum,” “field addition,” and “partition table.”

As illustrated, the extracted keywords, including the feature keywords 320 and the team-specific keywords 325, are transmitted to the mapping generation component 330. In the illustrated example, the mapping generation component 330 is configured to generate keyword mappings 335 that correlate the feature keywords 320 to the team-specific keywords 325 with similar meanings. In some embodiments, the mappings 335 may be established based on semantic relationships or contextual similarities through NLP techniques or other predefined correlation rules. For example, the feature keyword “storage size” may be mapped to team-specific keywords like “memory field,” “storage property,” and “field addition.” These keywords are mapped together because they all relate to the concept of storage capacity. The feature keyword “partition” may be mapped to team-specific keywords like “virtual server,” “LPAR,” and “partition table.” These connections are established because “partition” in the context of the feature request overlaps with “virtual server” in mobile app settings, “LPAR” in hardware management contexts, and “partition table” in database structures.

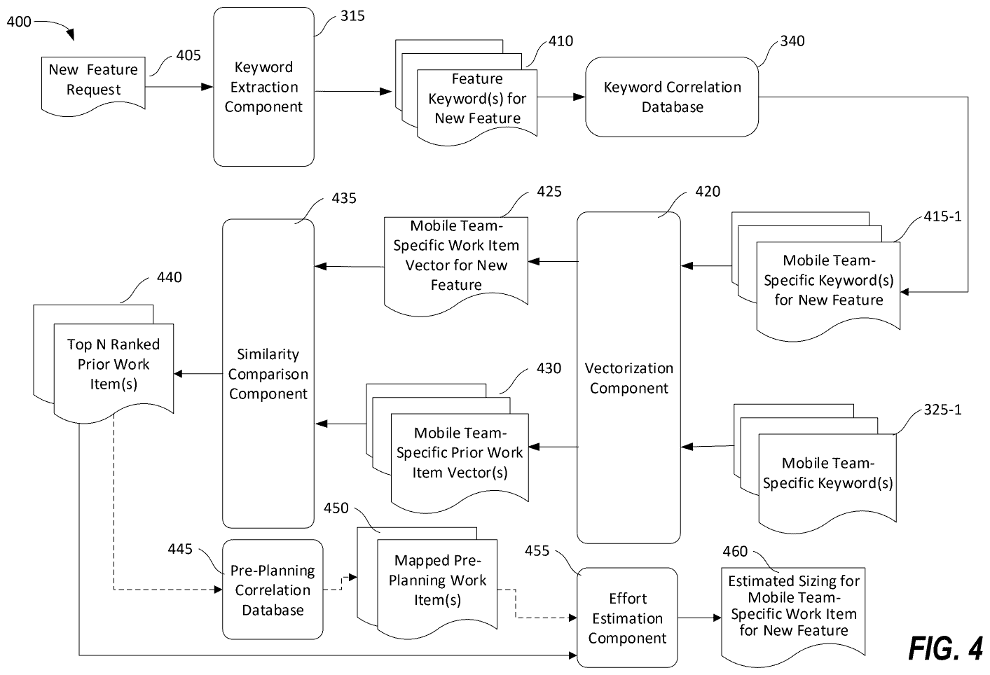

The generated keyword mappings 335 are then stored in the keyword correlation database 340. The keyword mappings 335 address the inconsistency in feature descriptions (e.g., 205-1 of FIG. 2) and work item descriptions (e.g., 210-1, 215-1, and 220-2) across different teams within a software development project. When a new feature request is received, the request often includes high-level descriptions that need to be broken down into smaller and manageable work items. The keywords 320 extracted from the feature descriptions may be used to search the keyword correlation database 340 for relevant team-specific keywords 325. Through these team-specific keywords 325, the system may suggest what work items should be performed by each team to achieve the new feature. Also, these team-specific keywords 325 may help quickly identify relevant prior work items as references for work item sizing prediction. More detail about work item sizing predictions for new feature requests is discussed below with reference to FIG. 4.

In some embodiments, the keyword extractions from feature descriptions and work item descriptions may be performed using NLP techniques, including but not limited to, RAKE (Rapid Automatic Keyword Extraction), Spacy, and TextRank. These tools are designed to automatically identify and extract relevant terms from large amounts of text. In some embodiments, keyword extraction may also be performed using a subject matter expert (SME), which requires an expert to manually review the descriptions and identify keywords. The involvement of SMEs may cost exponentially longer time, but it can ensure the extracted keywords are contextually relevant and technically precise. In some embodiments, a combination of NLP techniques and SME involvement may be utilized to enhance the accuracy and relevance of keyword extraction processes.

The illustrated completed feature request 305 involves collaboration among three teams (e.g., the mobile team, the application team, and the database team), each team having a respective team-specific work item 310 and working collectively to achieve the feature. The completed feature request 305 is provided for conceptual clarity. In some embodiments, the completion (or implementation) of a feature may involve any number of teams, deepening on the complexity and scope of the project. Additionally, in some embodiments, each team may be assigned more than one work item.

In embodiments where there are multiple completed feature requests 305, the keyword mapping generation process may be repeated for each completed feature request, and the relevant keyword mappings may be saved in the database 340. With more keyword mappings saved, the database 340 becomes a rich repository of historical data, which can be used to provide more precise and relevant mappings for future new feature requests.

FIG. 4 depicts an example of a workflow 400 for predicting team-specific item sizings for a new feature request, according to some embodiments of the present disclosure.

In the illustrated workflow 400, a new feature request 405 is provided to the keyword extraction component 315. For example, the new feature request may include descriptions like “enhance ABC Mobile App to display a VM's minimum storage size.” As used herein, the ABC Mobile App is a different application from the HMC Mobile App. The descriptions of the new feature request 405 is processed by the keyword extraction component 315 (using NPL and/or SMEs) to generate a set of keywords 410, such as “VM,” “virtual machine,” “minimum,” “and “storage size.”

The extracted feature keywords 410 are then used to search through the keyword correlation database 340. The database 340, as discussed above, has established correlations that link general feature keywords with team-specific keywords. For example, the feature keywords “VM” and “virtual machine” may be linked to team-specific keywords like “partition,” “virtual server,” “LPAR,” and “partition table.” The feature keyword “storage size” may be correlated with team-specific keywords like “memory field,” “storage property,” and “field addition.”

When the identified team-specific keywords involve more than one team, the system may categorize the keywords into different groups. For example, in the feature request 405 involving the enhancement of the ABC Mobile App to display a VM's minimum storage size, the keywords can be divided into three groups, such as mobile team-specific keywords 415-1, application team-specific keywords 415-2 (not shown), and database team-specific keywords 415-3 (not shown). The mobile team-specific keywords 415-1 may include terms such as “minimum,” “memory field,” and “virtual server.” The application team-specific keywords 415-2 (not shown) may include terms like “minimum,” “storage property,” and “LPAR.” The database team-specific keywords 415-3 (not shown) may include terms like “minimum,” “field addition,” and “partition table.” These groups of keywords may then be processed to generate vectors for similarity comparison.

As illustrated, the mobile team-specific keywords 415-1 are provided to the vectorization component 420 to generate a vector that represents the mobile team-specific work item. Various techniques may be used for vectorizing the team-specific keywords, including but not limited to, Bag of Words, TF-IDF, or contextual work embeddings (e.g., ELMo, BERT).

The generated vector 425 from the mobile team-specific keywords represents the task that the mobile team needs to complete in order to implement the new feature (enhancing the ABC Mobile App to display a VM's minimum storage size). Additionally, based on the extracted mobile team-specific keywords (such as “memory field” and “virtual server”), the system may identify a variety of relevant prior work items performed by the mobile team for other completed features. Examples of these prior work items may include: adding a new minimum memory field, adding a new maximum memory field to the virtual server profile view, updating storage visualization for VMs, implementing real-time data updates in VM profiles, and the like. Each of the identified prior work items may include a set of keywords 325-1 that describe the important aspects of each task. These keywords 325-1 for each prior work item are processed by the vectorization component 420, which utilizes techniques like Bag of Words, TF-IDF, or contextual embeddings to convert these textual keywords into a vector 430. Each vector 430 represents a respective prior work item. In some embodiments, the vectors 430 for the prior work items and the vector 425 for the new feature's work item may be generated in the same vector space for similarity comparison.

In the illustrated example, the similarity comparison component 435 compares the vector 425 of the new feature's work item (for the mobile team) with the vector 430 of each identified prior work item (for the mobile team). The component 435 may use similarity metrics like cosine similarity or Euclidean distance to generate a similarity score for each prior work item. Based on the similarity scores calculated, the component 435 outputs the top “N” ranked prior work items 440 with the highest similarity scores. The value “N” can be any number. In some embodiments, instead of fixing the number of selected prior work items, the similarity comparison component 435 may define a threshold for the similarity scores (like 0.75 for cosine similarity). If the similarity score of a prior work item exceeds the threshold, the work item will be selected. The selected prior work items 440 are considered more likely to be related to the new feature's work item, and their corresponding actual sizings (or, in some embodiments, their estimated sizings) are then provided to the effort estimation component 455, which is configured to predict the sizing 460 of the mobile team-specific work item for the new feature. When more than one prior work is selected, each with varying sizings, a weighted average is calculated to estimate the effort required for the new work item.

In some embodiments, to calculate the weighted average, each selected mobile team-specific prior work item may be assigned a weight based on its similarity to the new feature's work item. Cosine similarity has a range from 0 to 1, and a higher cosine similarity (closing to 1) indicates a higher degree of relevance, suggesting the context and/or requirements of the prior work item closely match those of the new work item. Suppose the similarity comparison component 435 has selected the top three ranked prior work items completed by the mobile team. The first ranked prior work team took 1 PM to complete (or, in some embodiments, was estimated to require 1 PM to complete) and has a cosine similarity of 0.8. The second ranked prior work item took 2 PM to complete (or, in some embodiments, was estimated to require 2 PM to complete) and has a cosine similarity of 0.75. The third ranked prior work item took 3 PM to complete (or, in some embodiments, was estimated to require 3 PM to complete) and has a cosine similarity of 0.5. The initial weight may be assigned based on the similarity between the prior work item and the new work item. Therefore, the initial weight assigned to the first ranked prior work item is 0.8, the initial weight assigned to the second ranked prior work item is 0.75, and the initial weight assigned to the third ranked prior work item is 0.5. The initial weight may then be normalized to ensure the sum of all weights is equal to 1. The normalization process can prevent any single prior work item from disproportionally affecting final estimation. To normalize the weights, in some embodiments, the sum of all initial weights may be calculated as follows: (0.8+0.75+0.5)=2.05.

In some embodiments, each weight may then be divided by the sum to generate a corresponding normalized weight. In some embodiments, the normalized weight for the first prior work item may be calculated as follows: 0.8/2.05=0.39. In some embodiments, the normalized weight for the second prior work item may be calculated as follows: 0.75/2.05=0.37. In some embodiments, the normalized weight for the third prior work item may be calculated as follows: 0.5/2.05=0.24.

Following the weight assignment and normalization, the weighted effort (measured in PM or hours) is calculated by multiplying the effort actually spent to complete each work (or, in some embodiments, the effort estimated to complete each work) by its corresponding normalized weight. In some embodiments, the weighted effort (or time) for the first prior work item may be calculated as follows: 1 PM×0.39=0.39 PM. In some embodiments, the weighted effort (or time) for the second prior work item may be calculated as follows: 2 PM×0.37=0.74 PM. In some embodiments, the weighted effort (or time) for the third prior work item may be calculated as follows: 3 PM×0.24=0.72 PM.

In some embodiments, the total weighted effort for the new work item may be calculated by summing the weighted efforts (or times): (0.39 PM+0.74 PM+0.72 PM)=1.85 PM.

In some embodiments, before estimating the effort for the new work item, the system may search the pre-planning correlation database 445 to check if any pre-planning activities (also referred to in some embodiments as pre-planning work items) are associated with the selected top “N” ranked prior work items 440. Pre-planning activities may refer to work that needed to be performed in an earlier release in preparation for the main work item. Without performing these activities, the introduction or implementation of the main work item may disrupt the normal operations of a computing system. Examples of pre-planning activities may include, but are not limited to, evaluating the risk of updating, performing architectural review and changes to prevent disruptions, mitigating data to prevent data loss and minimize downtime, or developing experimental prototypes to test new concepts before full-scale implementation.

In some embodiments, the pre-planning correlation database 445 may include dictionary mappings between prior work items and pre-planning activities. In some embodiments, there may be four types of correlations between a pre-planning activity and its associated work item, including pre-planning activity pointing to work item (indicating that the pre-planning efforts directly contribute to the main task), work item pointing to pre-planning activity (indicating that the pre-planning efforts benefit from the main task), self-described pre-planning work (indicating the work item is inherently pre-planning), and references to another line item (indicating an indirect reference between pre-planning effort and the main task). The first three types of correlation indicate a direct mapping, while the fourth type indicates an indirect reference. By searching the pre-planning correlation database 445, one or more pre-planning activities 450 mapped to each selected top-rated work item are identified.

For the example discussed above, suppose that the similarity comparison component 435 outputs three top-rated prior work items previously completed by the mobile team. For the first ranked prior work item, two pre-planning activities are mapped. The first pre-planning activity directly contributes to the first prior work item (e.g., pre-planning activity pointing to work item), and the second pre-planning activity is indirectly referenced to the first prior work item (e.g., references to another line item). To estimate the effort required for pre-planning for the first prior work item, weights may be assigned to the identified pre-planning activities based on their mapping strength in the dictionary (e.g., a weight of 1 for direct mapping, and a weight of 0.5 for indirect reference). The weights assigned to each pre-planning activity may then be normalized to sum to 1, leading to a weight of 0.67 for the first pre-planning activity and a weight of 0.33 for the second pre-planning activity. If the first pre-planning activity requires 3 PM to complete, and the second pre-planning activity requires 2 PM to complete, the estimated pre-planning effort (or time) for the first ranked prior work item may be calculated as follows: (3 PM×0.67)+(2 PM×0.33)=2.67 PM.

The estimated pre-planning effort may then be added to the effort for the first prior work item (like 1 PM) to generate a total effort of 3.67 PM for the first ranked prior work item. The total effort of 3.67 PM may then be multiplied by the normalized weight of 0.39 from the initial effort estimation process to generate the normalized effort (or time) for the first prior work item, as: (1 PM+2.67 PM)×0.39=1.43 PM.

Assuming no other pre-planning activities are mapped to the second and third ranked prior work items, making the normalized efforts of 0.74 PM and 0.72 PM unchanged. In some embodiments, the total weighted effort (or time) 460 for the mobile team-specific work item may be calculated as follows: (1.43 PM+0.74 PM+0.72 PM)=2.89 PM.

The integration of pre-planning sizing into the main work item sizing estimation ensures that all necessary preliminary activities are considered, and therefore provides a more accurate estimate of the total efforts required by a specific team (in this example, the mobile team) to implement the new feature.

In some embodiments, the work item sizing estimation process may be repeated for all teams involved in the new feature request. As discussed above, the new request concerning the enhancement of the ABC Mobile App to display a VM's minimum storage size may be achieved through collaboration among three teams: the mobile team, the application team, and the database team. The example workflow 400 only depicts how sizing for the mobile team-specific work item is predicted. The example workflow 400 is provided for conceptual clarity. In some embodiments, the sizing estimation process may be repeated to predict the efforts required for the application team-specific work item and the database team-specific work item, respectively. The total estimated effort for the entire new feature is then calculated by summing up these individual efforts. As discussed above, the total weighted effort 460 for the mobile team-specific work item is 2.89 PM. Suppose the estimated effort for the application team-specific work item is 4 PM, and the estimated effort for the database team-specific work item is 5 PM. The total estimated effort (or time) for implementing the new feature may be calculated as follows: (2.89 PM+4 PM+5 PM)=11.89 PM.

In some embodiments, the implementation of a new feature may incur certain defects that require additional efforts to address. For example, a request that introduces a new data synchronization feature in a cloud storage application may potentially cause defects like data inconsistency. As used herein, defects may refer to unintended behaviors or errors in a software component that do not align with the software's requirements or user expectations, such as errors that affect its functionality or degrade its performance.

To further enhance the accuracy of sizing estimation, the system may incorporate defect data into consideration, making the final estimation for the new feature also include the additional efforts required to address related defects. In some embodiments, the system may first extend the keyword correlation database 340 to include defect-related keywords. The keywords of a defect may then be mapped to the keywords of a completed feature that the defect relates to, forming mappings between known defects and completed features. When a new feature request 405 is received, the keyword extraction component 315 may use the extracted feature keywords 410 to search the database 340 for any defect-related keywords that correspond to the new feature request. In some embodiments, the search may also consider team-specific keywords if defects are known to be more frequent in certain areas or handled by certain teams. Following the identification of the defect-related keywords, the vectorization component 420 may compile these keywords into a defect vector, which represents the defect profile associated with the new feature request. The similarity comparison component 435 may then compare the defect vector with vectors of previously addressed defects, to identify top “N” defects that are most closely related to the new request. The comparison may be conducted using techniques like cosine similarity or Euclidean distance. If one defect is identified as being correlated to the new feature request, the effort estimation component 455 may incorporate the amount of effort estimated to resolve the defect (or, in some embodiments, the effort previously taken to resolve the defect) into the total effort estimation for the new feature. If multiple defects are identified, the effort estimation component 455 may calculate a weighted average for the efforts required to resolve the defects based on their relevance (or similarity) to the defect profile for the new feature request. In some embodiments, the final estimation includes both the effort for developing the new feature and the additional effort potentially required to address related defects.

In some embodiments, instead of or in addition to keyword identification, the similarity comparison component 435 may use techniques such as document summarization and comparison to determine the similarity between work items for the new feature and completed work items. The similarity scores outputted from the document comparison may then utilized as weights for estimating the sizing of the new team-specific work item.

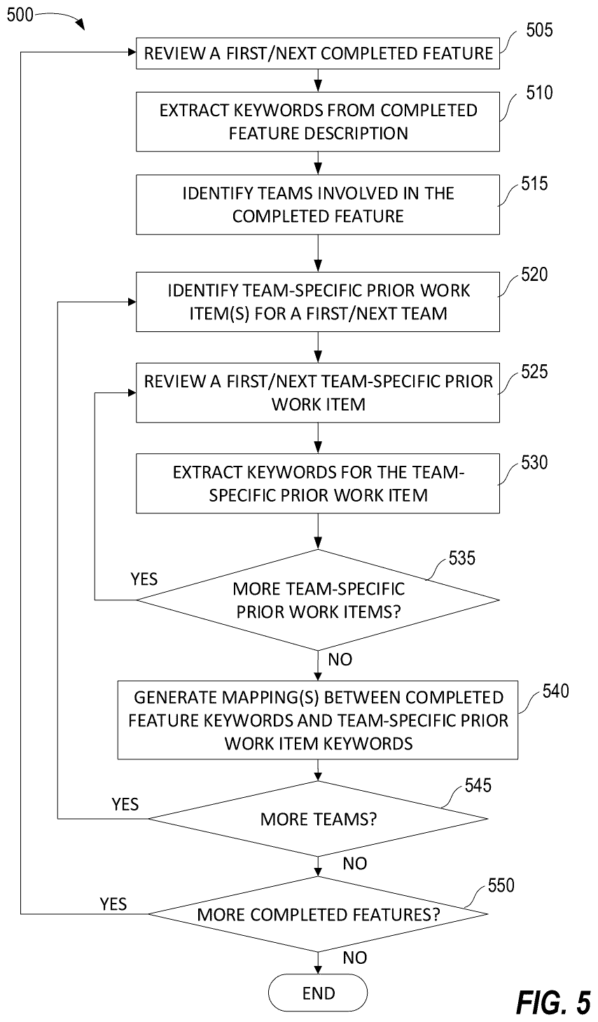

FIG. 5 depicts an example method 500 for generating and storing keyword mappings in a correlation database, according to some embodiments of the present disclosure. In some embodiments, the method 500 may be performed by one or more computing devices or systems, such as the computer 101 as illustrated in FIG. 1, and/or the keyword extraction component 315, or the mapping generation component 330 as illustrated in FIG. 3.

The method 500 begins at block 505, where a computing device (e.g., 101 of FIG. 1) reviews a completed feature request (e.g., 305 of FIG. 3) to understand its scope and impact. As depicted in FIG. 2, a feature request may include a text description (e.g., 205-1), which defines the feature's functionality and requirements.

At block 510, the computing device analyzes the feature's description (e.g., 205-1) to extract keywords (e.g., 320 of FIG. 3).

At block 515, the computing device identifies teams that contribute to the development of the completed feature, which may include the mobile team, the application team, and the database team, among others. For each team involved, their specific work items related to the completed feature are also identified.

At block 520, the computing device focuses on the first team (e.g., the mobile team) involved, identifying any prior work items (e.g., 310-1 of FIG. 3) that were performed by the first team as part of the implementation of the completed feature.

Following the identification of prior work items associated with the first team, the computing device proceeds to review each prior work item individually. At block 525, the computing system reviews the first prior work item (e.g., 310-1 of FIG. 3), among all identified prior work items for the first team. As discussed above, each work item (e.g., 210 of FIG. 2) includes a text description (e.g., 210-1 of FIG. 2) that details the specific tasks assigned to the team.

At block 530, the computing device processes the description (e.g., 210-1 of FIG. 2) of the first prior work item to extract team-specific keywords (e.g., 325-1 of FIG. 3). In some embodiments, the team-specific keywords may highlight the technical or functional requirements of the task assigned to the first team.

At block 535, the computing device checks if there are additional prior work items for the first team (e.g., 310-1 of FIG. 3) that need to be analyzed. If the computing device identifies that there are more prior work items that have not yet been reviewed and documented, the method 500 returns to block 525, where the computing device reviews the second (or next) prior work item among all identified prior work items for the first team. The checking is to ensure that all relevant work items completed by the first team are analyzed and recorded. If all work items for the first team have been properly reviewed and documented, the method 500 proceeds to block 540.

At block 540, the computing system generates mappings (e.g., 335 of FIG. 3) between the keywords for the completed feature (e.g., 320 of FIG. 3) and the team-specific keywords for prior work items completed by the first team (e.g., the mobile team) (e.g., 325-1 of FIG. 3). In some embodiments, the generated mappings may then be saved in a keyword correlation database (e.g., 340 of FIG. 3) for future new feature request processing.

After completing the review of all prior work items for the first team, at block 545, the computing device evaluates whether additional teams were involved in the implementation of the completed feature (e.g., 305 of FIG. 3). If another team was involved and needs to be analyzed, the method 500 returns to block 520, where the computing device begins the keyword extraction and mapping processes for the second (or next) team involved (e.g., the application team). If no other team is involved, the method 500 proceeds to block 550.

At block 550, the computing device determines whether there are additional completed feature requests to process. If there are more completed feature requests to process, the method 500 loops back to block 505, where the computing device begins the keyword extraction and mapping processes for the second (or next) completed feature request. Otherwise, the method 500 ends.

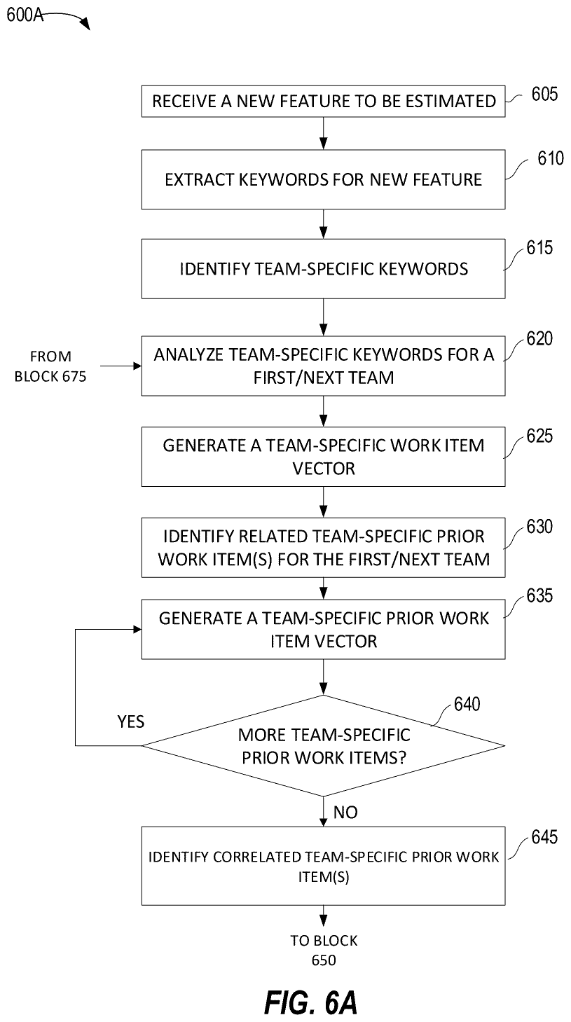

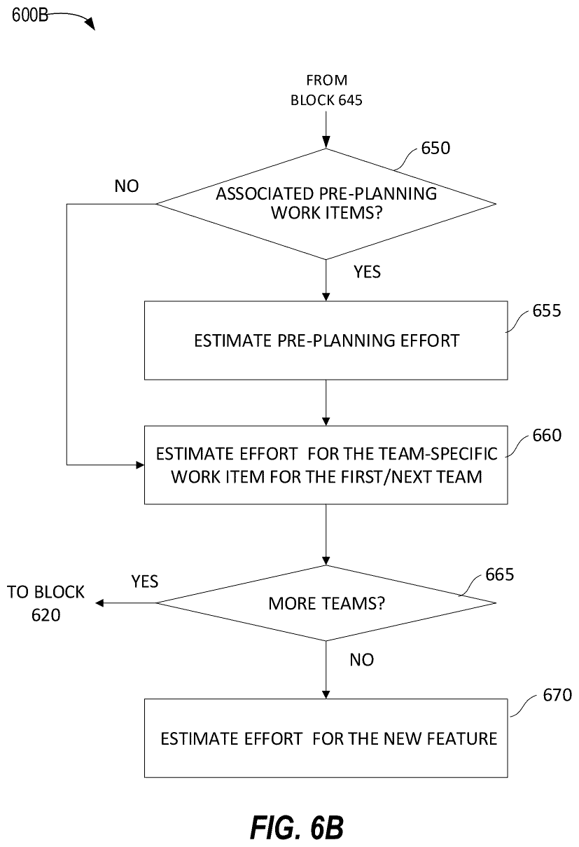

FIGS. 6A and 6B depict an example method 600 for estimating sizings for team-specific work items in new feature development, according to some embodiments of the present disclosure. In some embodiments, the method 600 may be performed by one or more computing devices or systems, such as the computer 101 as illustrated in FIG. 1, and/or the keyword extraction component 315, the vectorization component 420, the similarity comparison component 435, or the effort estimation component 455 as illustrated in FIG. 4.

At block 605 of FIG. 6A, a computing device (e.g., 101 of FIG. 1) receives a new feature request (e.g., 405 of FIG. 4). As discussed in FIG. 2, the request may include a detailed text description (e.g., 205-1 of FIG. 2) of the new feature that needs to be implemented.

At block 610, the computing device processes the text description to extract relevant feature keywords for the new request (e.g., 410 of FIG. 4).

At block 615, based on the extracted feature keywords (e.g., 410 of FIG. 4) (and/or the nature of the new request), the computing device searches through an established keyword correlation database (e.g., 340 of FIGS. 3 and 4). The search may involve matching the new feature's keywords with entries in the database (e.g., 335 of FIG. 3) to find related team-specific keywords (e.g., 415-1 of FIG. 4). In embodiments where the identified team-specific keywords span across multiple teams (e.g., the mobile team, the application team, and the database team), the computing device may categorize these keywords into different groups according to the relevant teams.

At block 620, the computing device focuses on analyzing the team-specific keywords associated with the first team (e.g., the mobile team) (e.g., 415-1 of FIG. 4) among all identified teams at block 615.

At block 625, the computing device creates a vector (e.g., 425 of FIG. 4) for the work item assigned to the first team as part of the implementation of the new feature. The generated vector represents the expected tasks and/or responsibilities assigned to the first team.

At block 630, using the team-specific keywords for the first team, the computing device searches for related prior work items that the first team has performed for other completed features. The system may retrieve each identified prior work item and the corresponding team-specific keywords (e.g., 325-1 of FIG. 4). For each identified prior work item, a vector (e.g., 430 of FIG. 4) may be generated to represent the tasks and/or functions performed by the first team.

At block 635, the computing device generates a vector (e.g., 430 of FIG. 4) for one identified prior work item.

At block 640, the computing device checks if there are more prior work items for the first item that need to be vectorized. If additional work items are found, the method 600 returns to block 635, where the keywords for another prior work item is processed for vector generation. The techniques used for vectorization may include Bag of Words, TF-IDF, or contextual work embeddings (e.g., ELMo, BERT). If no further work items are found, the method 600 proceeds to block 645.

At block 645, the computing device compares the vector representing the new work item (e.g., 425 of FIG. 4) (generated at block 625) with the vector(s) representing related prior work item(s) (e.g., 430 of FIG. 4) (generated at block 635). The comparison is conducted to determine the similarity between the new feature's tasks and those previously performed by the first team. In some embodiments, the computing device may use cosine similarity or Euclidean distance to measure the degree of correlation (or similarity) between vectors. A higher cosine similarity score (closing to 1) indicates a higher degree of correlation, suggesting that the prior work item is more likely be relevant to the new work item. Based on the similarity scores, the computing system may identify one or more highly correlated prior work items performed by the first team. In some embodiments, the device may return the top “N” ranked prior work items with the highest cosine similarity scores. In some embodiments, the device may set a similarity score threshold, and all prior work items that pass the threshold may be returned as highly relevant.

Turning now to FIG. 6B, at block 650, the computing device checks whether any pre-planning activities (or actions) are associated with the prior work items identified at block 650 (e.g., 440 of FIG. 4). In some embodiments, the check may be performed using a pre-planning correlation database (e.g., 445 of FIG. 4), which includes dictionary mappings between team-specific work items and pre-planning activities. If no pre-planning activities are identified, the method 600 proceeds to block 660, where the computing device calculates the effort (or time) for completing the new work item by the first team. If one or more pre-planning activities are identified, the method 600 proceeds to block 655, where the computing device calculates the effort required for these pre-planning activities. In embodiments where multiple pre-planning activities are identified as associated with a prior work item, the computing device may calculate a weighted average of their efforts (or times) based on correlations or mapping strengths in the dictionary (e.g., direct mapping, indirect reference).

At block 660, the computing device integrates the estimated pre-planning effort into the overall estimation for the new work item assigned to the first team. In embodiments where multiple correlated prior work items are identified at block 650, the computing device may calculate a weighted average of their efforts (or times) based on their similarity to the new work item.

At block 665, the computing device evaluates whether additional teams are involved in implementing the new feature. If other teams (e.g., the application team, the database team) are involved, the method 600 returns to block 620, where the computing device repeats the analysis for the second (or next) team. The evaluation ensures that each team's effort (or time) as part of the implementation of the new feature is accurately estimated. If no other teams are involved, the method 600 proceeds to block 670.

At block 670, after all individual team's efforts (or times) (including pre-planning efforts) have been estimated, the computing device calculates the total efforts (or times) required for implementing the new feature. In some embodiments, the system may incorporate pre-planning efforts that were identified into the final estimation, and sum up the efforts (or times) for each team's specific work items.

In some embodiments, following the effort for each team's specific work item has been estimated, the computing device may perform additional operations for defect checking, to identify any potential defects associated with the new feature request. In some embodiments, the system may utilize the keyword correlation database (e.g., 340 of FIG. 4) to search for defects that have historically been associated with similar features. In embodiments where only one defect is identified as being correlated to the new feature request, at block 670, the computing device may add the estimated effort (or time) to resolve the defect (or, in some embodiments, the effort previously taken to resolve the defect) into the total effort estimation for the new feature. In embodiments where multiple defects are identified, at block 670, the computing device may calculate a weighted average for the resolution efforts (or times) based on their relevance to the new feature request. The weighted average may then be added into the total effort estimation for the new feature.

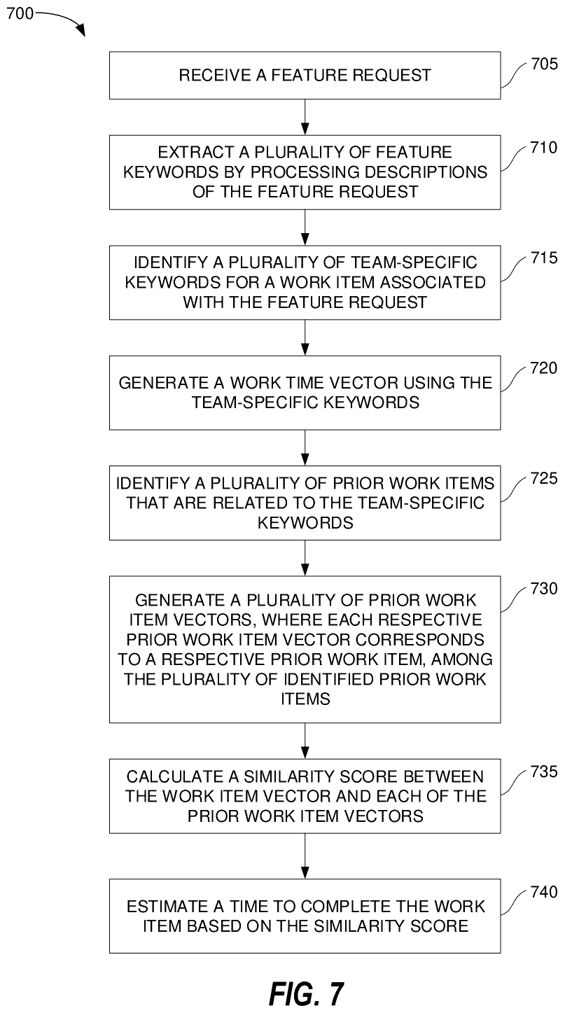

FIG. 7 is a flow diagram depicting an example method 700 for work item sizing predictions, according to some embodiments of the present disclosure.

At block 705, a computing device (e.g., 101 of FIG. 1) receives a feature request (e.g., 405 of FIG. 4).

At block 710, the computing device extracts a plurality of feature keywords (e.g., 410 of FIG. 4) by processing descriptions (e.g., 205-1 of FIG. 2) of the feature request.

At block 715, the computing device identifies a plurality of team-specific keywords (e.g., 415-1 of FIG. 4) for a work item associated with the feature request. In some embodiments, to identify the plurality of team-specific keywords (e.g., 415-1 of FIG. 4) for the work item, the computing device may search a keyword correlation database (e.g., 340 of FIGS. 3 and 4) that stores mappings (e.g., 335 of FIG. 3) between feature keywords (e.g., 320 of FIG. 3) and team-specific keywords extracted from one or more completed feature requests (e.g., 325 of FIG. 3).

In some embodiments, the keyword correlation database (e.g., 340 of FIGS. 3 and 4) may be generated by extracting a plurality of completed feature keywords (e.g., 325 of FIG. 3) by processing descriptions (e.g., 205-1 of FIG. 2) of a completed feature request (e.g., 305 of FIG. 3), identifying a plurality of team-specific prior work items (e.g., 310 of FIG. 3) associated with the completed feature request, for each identified team-specific prior work item associated with the completed feature request, extracting a plurality of team-specific prior work item keywords (e.g., 325 of FIG. 3), and generating one or more entries (e.g., 335 of FIG. 3) in the keyword correlation database that maps the plurality of completed feature keywords to the plurality of team-specific prior work item keywords.

At block 720, the computing device generates a work item vector (e.g., 425 of FIG. 4) using the team-specific keywords (e.g., 415-1 of FIG. 4).

At block 725, the computing device identifies a plurality of prior work items that are related to the team-specific keywords.

At block 730, the computing device generates a plurality of prior work item vectors (e.g., 430 of FIG. 4), where each respective prior work item vector corresponds to a respective prior work item, among the plurality of identified prior work items.

At block 735, the computing device calculates a similarity score between the work item vector and each of the prior work item vectors. In some embodiments, to calculate the similarity score between the work item vector and each of the prior work item vectors, the computing device may use a cosine similarity metric or a distance similarity metric.

At block 740, the computing device estimates a time (e.g., 460 of FIG. 4) (also referred to in some embodiments as effort or sizing) to complete the work item based on the similarity score. In some embodiments, to estimate the time to complete the work item, the computing device may assign a weight to each respective prior work item based on the similarity score between the work item vector and a respective prior work item vector, where each respective prior work item has a respective recorded historical time. For each prior work item, the computing device may multiply the recorded historical time by the assigned weight to generate a weighted historical time. The computing device may then calculate the time to complete the work item by summing the weighted historical times for each prior work item.

In some embodiments, the computing device may further select one or more prior work items (e.g., 440 of FIG. 4), from the plurality of prior work items, that each has a similarity score exceeding a defined threshold, and estimate the time (e.g., 460 of FIG. 4) to complete the work item based on the similarity scores of the one or more prior work items.

In some embodiments, the computing device may access a pre-planning correlation database (e.g., 445 of FIG. 4) to identify one or more pre-planning activities (e.g., 450 of FIG. 4) related to each of the plurality of prior work items, where each respective prior work item has a respective first recorded historical time, and each respective pre-planning activity has a respective second recorded historical time. In some embodiments, the computing device may calculate the time (e.g., 460 of FIG. 4) to complete the work item using the similarity scores, the first recorded historical times, and the second recorded historical times.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving a feature request;
extracting a plurality of feature keywords by processing one or more descriptions of the feature request;
identifying a plurality of team-specific keywords for a work item associated with the feature request;
generating a work item vector using the team-specific keywords;
identifying a plurality of prior work items that are related to the team-specific keywords;
generating a plurality of prior work item vectors, wherein each respective prior work item vector corresponds to a respective prior work item, among the plurality of identified prior work items;
calculating a similarity score between the work item vector and each of the prior work item vectors; and
estimating a time to complete the work item based on the similarity score.

2. The method of claim 1, wherein estimating the time to complete the work item comprises:
assigning a weight to each respective prior work item based on the similarity score between the work item vector and a respective prior work item vector, wherein each respective prior work item has a respective recorded historical time;
for each prior work item, multiplying the recorded historical time by the assigned weight to generate a weighted historical time; and
calculating the time to complete the work item by summing the weighted historical times for each prior work item.

3. The method of claim 1, further comprising:
selecting one or more prior work items, from the plurality of prior work items, that each has a similarity score exceeding a defined threshold; and
estimating the time to complete the work item based on the similarity scores of the one or more prior work items.

4. The method of claim 1, wherein calculating the similarity score between the work item vector and each of the prior work item vectors comprises using a cosine similarity metric or a distance similarity metric.

5. The method of claim 1, wherein identifying the plurality of team-specific keywords for the work item comprises searching a keyword correlation database that stores mappings between feature keywords and team-specific keywords extracted from one or more completed feature requests.

6. The method of claim 5, wherein the keyword correlation database is generated by:
extracting a plurality of completed feature keywords by processing descriptions of a completed feature request;
identifying a plurality of team-specific prior work items associated with the completed feature request;
for each identified team-specific prior work item associated with the completed feature request, extracting a plurality of team-specific prior work item keywords; and
generating one or more entries in the keyword correlation database that maps the plurality of completed feature keywords to the plurality of team-specific prior work item keywords.

7. The method of claim 1, further comprising:
accessing a pre-planning correlation database to identify one or more pre-planning activities related to each of the plurality of prior work items, wherein each respective prior work item has a respective first recorded historical time, and each respective pre-planning activity has a respective second recorded historical time; and
calculating the time to complete the work item using the similarity scores, the first recorded historical times, and the second recorded historical times.

8. A system, comprising:
one or more computer processors; and
one or more memories collectively containing one or more programs, which, when executed by the one or more computer processors, perform operations, the operations comprising:
receiving a feature request;
extracting a plurality of feature keywords by processing descriptions of the feature request;
identifying a plurality of team-specific keywords for a work item associated with the feature request;
generating a work item vector using the team-specific keywords;
identifying a plurality of prior work items that are related to the team-specific keywords;
generating a plurality of prior work item vectors, wherein each respective prior work item vector corresponds to a respective prior work item, among the plurality of identified prior work items;
calculating a similarity score between the work item vector and each of the prior work item vectors; and
estimating a time to complete the work item based on the similarity score.

9. The system of claim 8, wherein, to estimate the time to complete the work item, the one or more programs, which, when executed by the one or more computer processors, perform the operations comprising:
assigning a weight to each respective prior work item based on the similarity score between the work item vector and a respective prior work item vector, wherein each respective prior work item has a respective recorded historical time;
for each prior work item, multiplying the recorded historical time by the assigned weight to generate a weighted historical time; and
calculating the time to complete the work item by summing the weighted historical times for each prior work item.

10. The system of claim 9, wherein the one or more programs, which, when executed by the one or more computer processors, perform the operations further comprising:
selecting one or more prior work items, from the plurality of prior work items, that each has a similarity score exceeding a defined threshold; and
estimating the time to complete the work item based on the similarity scores of the one or more prior work items.

11. The system of claim 9, wherein, to calculate the similarity score between the work item vector and each of the prior work item vectors, the one or more programs, which, when executed by the one or more computer processors, perform the operations comprising using a cosine similarity metric or a distance similarity metric.

12. The system of claim 9, wherein, to identify the plurality of team-specific keywords for the work item, the one or more programs, which, when executed by the one or more computer processors, perform the operations comprising searching a keyword correlation database that stores mappings between feature keywords and team-specific keywords extracted from one or more completed feature requests.

13. The system of claim 12, wherein the keyword correlation database is generated by:
extracting a plurality of completed feature keywords by processing descriptions of a completed feature request;
identifying a plurality of team-specific prior work items associated with the completed feature request;
for each identified team-specific prior work item associated with the completed feature request, extracting a plurality of team-specific prior work item keywords; and
generating one or more entries in the keyword correlation database that maps the plurality of completed feature keywords to the plurality of team-specific prior work item keywords.

14. The system of claim 9, wherein the one or more programs, which, when executed by the one or more computer processors, perform the operations further comprising:
accessing a pre-planning correlation database to identify one or more pre-planning activities related to each of the plurality of prior work items, wherein each respective prior work item has a respective first recorded historical time, and each respective pre-planning activity has a respective second recorded historical time; and
calculating the time to complete the work item using the similarity scores, the first recorded historical times, and the second recorded historical times.

15. One or more non-transitory computer-readable media containing, in any combination, computer program code, which, when executed by a computer system, performs operations comprising:
receiving a feature request;
extracting a plurality of feature keywords by processing descriptions of the feature request;
identifying a plurality of team-specific keywords for a work item associated with the feature request;
generating a work item vector using the team-specific keywords;
identifying a plurality of prior work items that are related to the team-specific keywords;
generating a plurality of prior work item vectors, wherein each respective prior work item vector corresponds to a respective prior work item, among the plurality of identified prior work items;
calculating a similarity score between the work item vector and each of the prior work item vectors; and
estimating a time to complete the work item based on the similarity score.

16. The one or more non-transitory computer-readable media of claim 15, wherein, to estimate the time to complete the work item, the computer program code, which, when executed by a computer system, performs operations comprising:
assigning a weight to each respective prior work item based on the similarity score between the work item vector and a respective prior work item vector, wherein each respective prior work item has a respective recorded historical time;
for each prior work item, multiplying the recorded historical time by the assigned weight to generate a weighted historical time; and
calculating the time to complete the work item by summing the weighted historical times for each prior work item.

17. The one or more non-transitory computer-readable media of claim 15, wherein the computer program code, which, when executed by a computer system, performs operations further comprising:
selecting one or more prior work items, from the plurality of prior work items, that each has a similarity score exceeding a defined threshold; and
estimating the time to complete the work item based on the similarity scores of the one or more prior work items.

18. The one or more non-transitory computer-readable media of claim 15, wherein, to identify team-specific keywords for the work item, the computer program code, which, when executed by a computer system, performs operations comprising searching a keyword correlation database that stores mappings between feature keywords and team-specific keywords extracted from one or more completed feature requests.

19. The one or more non-transitory computer-readable media of claim 18, wherein the keyword correlation database is generated by:
extracting a plurality of completed feature keywords by processing descriptions of a completed feature request;
identifying a plurality of team-specific prior work items associated with the completed feature request;
for each identified team-specific prior work item associated with the completed feature request, extracting a plurality of team-specific prior work item keywords; and
generating one or more entries in the keyword correlation database that maps the plurality of completed feature keywords to the plurality of team-specific prior work item keywords.

20. The one or more non-transitory computer-readable media of claim 15, wherein the computer program code, which, when executed by a computer system, performs operations further comprising:
accessing a pre-planning correlation database to identify one or more pre-planning activities related to each of the plurality of prior work items, wherein each respective prior work item has a respective first recorded historical time, and each respective pre-planning activity has a respective second recorded historical time; and
calculating the time to complete the work item using the similarity scores, the first recorded historical times, and the second recorded historical times.
